(19) United States
(12) Patent Application Publication
(10) Pub. No.: US 2005/0084191 A1
(43) Pub. Date: Apr. 21, 2005

(54) Bearing device for a gear

(75) Inventors: Heiner Fees, Bietigheim-Bissingen (DE); Roland Keller, Bergtheim (DE); Ekkehard Kraft, Retzstadt (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/968,799

(22) Filed: Oct. 20, 2004

(30) Foreign Application Priority Data
Oct. 21, 2003 (DE) 03 023 922.2

(51) Int. Cl. F16C 33/02

(52) U.S. Cl. 384/276

(57) ABSTRACT

Bearing device, especially for a gear A bearing device, especially for a gear, comprises a housing part (8) made of plastic, a bearing shell (1) with a cylindrical sheath-shaped ring section (2) as well as a radial section (3) held in the housing part (3) adjoining this, an inner shaft (6) guided in the bearing shell (1) on a first journal (9) and a second rotatable part (11,16) guided on a second journal (10) of the bearing shell (1), surrounding the inner shaft.

### The invention relates to a bearing device for at least two coaxially rotatable parts, which run on bearings in and/or on part of a housing, especially of a gear.

Gear housings, especially for lower-power drives, for example electric motors acting as auxiliary drives in motor vehicles, are frequently made of plastic. A spider made of metal is frequently provided to support a shaft in the housing. One of the factors determining the minimum axial extent of the spider are the forces which are to be introduced into the plastic housing via the spider, where the most critical area is the connection between the spider and the plastic housing. The mounting space, i.e. axial extent of the gear thus depends essentially not only on the number and dimensioning of the part rotating coaxially to the shaft in the gear but also on the forces to be accepted by the transmission housing.

The transmission housing known from document U.S. Pat. No. 4,748,865 includes a bearing device for a worm gear with a central cylindrical bearing spider. The drive shaft of a worm gear is supported on the inside of the bearing spider. The worm wheel is supported on the outside of the bearing spider.

In this case the bearing spider is formed entirely from the plastic material of the drive housing as one piece with the housing. The maximum bearing forces that can be accepted are in this case limited to a very low level by the material properties of the plastic.

Document EP 0 403 284 A1 discloses a further embodiment of a gear housing with a central journal To strengthen the journal of the plastic housing a metal plate is enclosed within the plastic at the journal.

The metal plate features a projecting cylindrical part in the area of the journal and extends with a flat part along the side surface of the drive housing from the shoulder of the projecting part to the outside circumference of the drive housing and partly beyond this into securing tabs in the housing, in order to take up the bearing forces. Depending on the diameter of the housing, this requires high material usage for the metal plate and increases both the weight and the manufacturing costs of the housing.

The object of the invention is to specify an especially compact bearing device, in particular for a drive, which comprises a housing made of plastic in and/or on which a number of coaxially rotatable parts are supported and with which the associated increased bearing forces can be securely taken up and directed into the housing. At the same time the use of additional material and thereby both the weight and also the costs are to be kept low.

In accordance with the invention this object is achieved by a support device with the features of claim 1. In this claim a metal bearing shell is held on a housing part made of plastic, which comprises an essentially cylindrical covering as well as a radial section attached to it. Within the ring section an inner shaft is guided on a first journal. A second, radial rotation body running outside the internal shaft is guided in a second journal of the bearing shell. Its radial section is used exclusively or predominantly to connect the housing section with the bearing shell. To this end at least the radial section of the bearing shell is injection moulded into the section of the housing, which extends at right angles to the shaft in this area. The introduction of the force of the bearing shell into the housing part at the radial section makes it possible to increase the dimensions of the force transfer part without the need for any increased axial mounting space. The radial section of the bearing shell which is essentially arranged at right angles to the shaft thus uses, for low-stress force introduction into the housing, at least predominantly the housing width rather than the housing length, without making the housing any wider.

An especially stable mounting of the radial section of the bearing shell in the plastic housing section is achieved by the radial section featuring notches on its side which give it the appearance of a star. Alternatively the radial section can have a wave form or another form as its outer contour for example, which increases the length enclosed by the plastic moulding. A comparable affect can also be achieved by holes made in the radial section or by a combination of holes and notches around the edge.

The first journal used to support the inner shaft is either formed directly by the metal surface of the bearing shell or by plastic. In the latter case this can be the plastic of the housing part and/or a plastic sheath of the bearing shell, where a plastic sheath is preferably embodied in one piece with the housing part. An especially stable connection between the plastic volume areas arranged within and outside the radial section is preferably established by the bearing shell, especially its radial section, featuring cut-outs into which the plastic penetrates.

A toothed wheel and/or a hollow shaft is provided as the outer rotatable part for example. This is supported on the bearing shell in a similar way to the inner shaft, either directly onto a mechanical surface of the bearing shell or onto a plastic sheath, whereby in each case axial guidance can also be provided in addition to radial guidance. An axial locking part for a toothed wheel supported on the ring section is preferably embodied as one piece with the ring section. In this case, using a particularly simple manufacturing technique, there is preferably a bent spring formed out of the ring section over which the toothed wheel is pushed on assembly. This means that an undercut for a locking ring to axially secure the toothed wheel is not required.

The advantage of the invention is especially that a single bearing shell made of metal serves as a multiple journal for parts rotating coaxially within a housing, especially a gear, in which case a particularly even introduction of the force from the bearing shell into the plastic housing part is produced, which avoids stress peaks by means of a radial section of the bearing shell arranged normally to the axis of rotation of the parts, which is injection moulded into the plastic housing part. The invention thus combines the specific advantages of plastic, especially as regards forming, with the advantages of metallic materials in relation to strength and wear.

A number of exemplary embodiments of the invention are explained in greater detail below on the basis of a drawing. The drawings show:

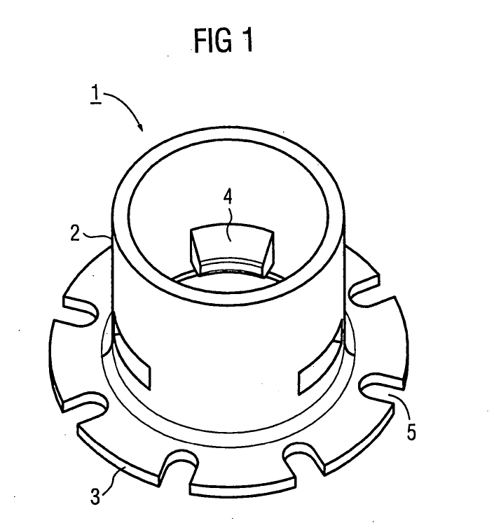

FIG. 1 a bearing shell in perspective view,

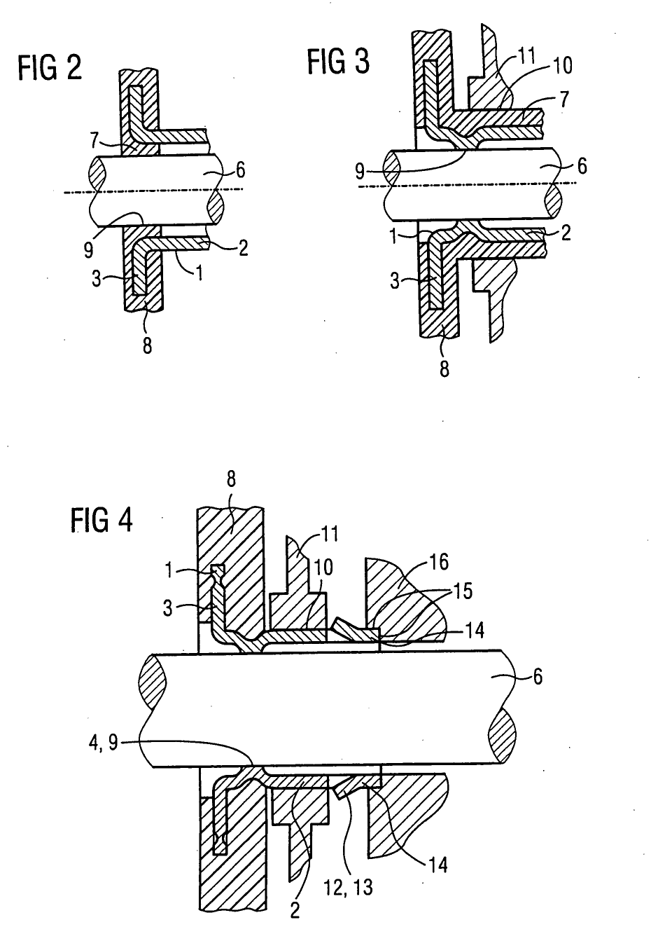

FIG. 2 a cross-section of an arrangement with a housing part of a bearing shell as well as an inner shaft,

FIG. 3 a cross-section of an arrangement with a housing part of the bearing shell, an inner shaft and also an outer rotating part,

FIG. 4 a cross-section of an arrangement with a housing part of the bearing shell, an inner shaft and also two outer rotating parts,

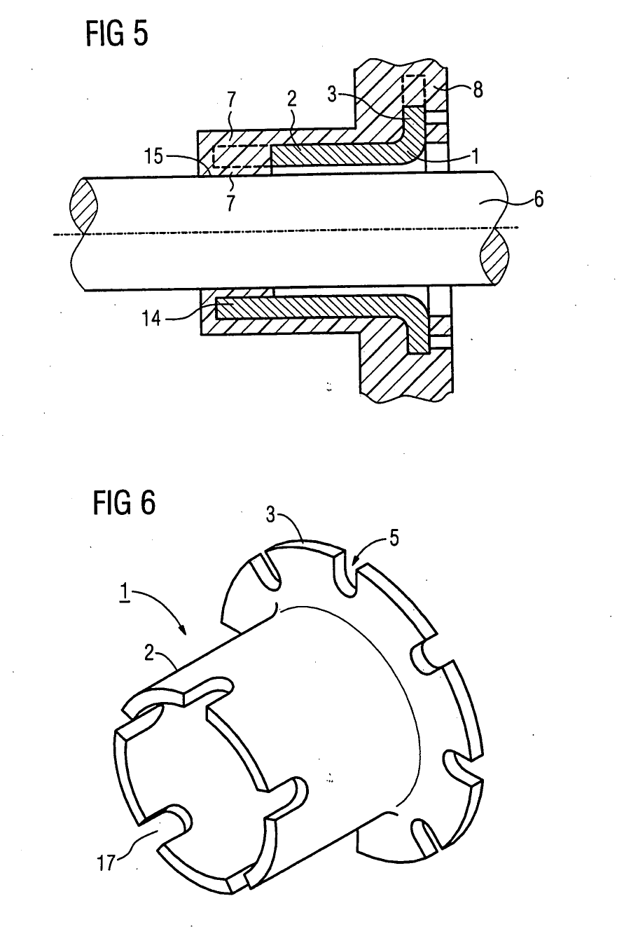

FIG. 5 a schematic cross sectional diagram of a support device with plastic-sheathed bearing shell and also

FIG. 6 a perspective view of the bearing shell.

Parts which correspond to each other or have the same effect are shown by the same reference characters in all of the Figures.

FIG. 1 shows a bearing shell 1 made from metal of a bearing device for a gear not included in the diagram, for example an electromechanical seat belt tensioner a window winding mechanism in a motor vehicle and also a roller conveyor drive for building systems.

The bearing shell 1 is for example manufactured as a punched-bent part from steel, as a turned part or as a sintered part and comprises a kind of cylindrical sheath-shaped ring section 2 as well as a radial section 3 joining this at right angles. The ring section 2 features a three beads 4 distributed evenly over the circumference which are formed in one piece from the metal of the bearing shell 1 and serve to support an axle not shown in this diagram which extends in the direction of the axis of symmetry of the bearing shell 1. Alternatively for example a single bead running around the ring section 2 can be implemented. Through a number of such circular beads a seal in relation to the shaft can be formed as a type of labyrinth seal.

The radial section adjoining and the ring section is provided for fixing into a plastic housing, especially for injection moulding into a plastic housing. A number of notches 5 arranged around the circumference of the radial section 3 in the exemplary embodiment according to FIG. 1 serve to enlarge the length of the bearing shell 1 enclosed in the moulding and thereby to increase the forces that can be transmitted the plastic housing.

The mounting for a bearing shell 1 similar to the embodiment shown in FIG. 1 can be seen from FIG. 2. Unlike the exemplary embodiment according to FIG. 1, in this Figure the support of a shaft 6, referred to hereafter as the inner shaft, is provided not directly on the bearing shell 1 but on a sheath 7 made of plastic. The sheath 7 on which the inner shaft 6 is supported on a first journal 9, simultaneously forms a part of a housing part 8 of a gear not included in the diagram. The radial section 3 is completely moulded into the housing part 8 manufactured by means of injection moulding, whereas the ring section 2 is arranged largely outside the housing part 8. By extending the radial section 3 at right-angles to the extension of the shaft 6 a large-surface force introduction into the housing part 8 is effected without additional mounting space in the housing, where notch stresses are borne by the mechanically-stable bearing shell 1 made from metal, especially its radial section 3.

The exemplary embodiment in accordance with FIG. 3 shows a support device with a bearing shell 1, on the metal surface of which, namely on a bead 4 forming a first journal 9, the shaft 6 is supported directly. A second journal 10 for a toothed wheel 11 as a further rotatable part is produced by an outer sheath 7 of the ring section 2 of the bearing shell 1. In a similar way to the exemplary embodiment in accordance with FIG. 2, in which the sheath 7 forms the first journal 9, the sheath 7 is also embodied in the exemplary embodiment in accordance with FIG. 3 in one piece with the housing part 8 of the gear.

A further exemplary embodiment of a support device is shown in FIG. 4. In this diagram both the inner shaft 6 and also the toothed wheel 11 are supported directly on an inner or outer metal surface of a ring section 2 of the bearing shell 1. An axial retaining part 12 for the toothed wheel 11 is formed by the bent springs 13 which are bent out from the metal of the ring section 2. On the front end 14 of the bearing shell 1 facing the radial section 3 is a third journal 15 for the axial and radial support of a hollow shaft 16 as a third rotatable part. Thus the bearing shell 1 functions as a multilayer journal for the axial and/or radial support of a plurality of toothed wheels and/or shafts. In the exemplary embodiment according to FIGS. 5 and 6 the inner shaft 6 is not supported in the area of the radial section 3 but at the front end 14 of the ring section 2. The sheath 7, which in this case is also embodied as one piece with the housing part 8, penetrates cut-outs 17 on the font end 14 of the ring section 2. The flanged star-shape radial section 3 essentially corresponds to the exemplary embodiment according to FIG. 1 and thus allows a large-area but still space-saving introduction of the force into the plastic housing part 8.

1. A device comprising,
a housing made of plastic, a bearing shell with an essentially cylindrical sheath-shaped ring section as a radial section adjoining and held in the housing part,
an inner shaft guided in the bearing shell on a first journal, a second rotatable part surrounding the inner shaft, guided on a second journal of the bearing shell, wherein the bearing shell is a metal shell whereby at least the radial section of the bearing shell is injection-moulded into the housing part and the bearing shell on the radial section has a form produced by notches on its edge and holes of the radial section, which changes the length enclosed by the plastic moulding.

2. The bearing device according to claim 1, wherein the ring section comprises a bead arranged to form the first journal.

3. The bearing device according to claim 1,
wherein the bearing shell comprises a sheath made from plastic and arranged to form the first journal.

4. The bearing device according to claim 3, wherein the sheath comprises a one piece housing.

5. The bearing device according to claim 3, wherein the bearing shell comprises, in the area of the first journal cutouts penetrated by the sheath.

6. The bearing device according to claims 1, further comprising a toothed wheel supported on the ring section.

7. The bearing device according to claim 6, further comprising an axial locking part for the toothed wheel embodied in one piece with the ring section.

8. The bearing device according to claim 7, wherein the axial locking part is embodied as a bent spring.

9. (canceled).

10. The bearing device according to claim 2, wherein the bearing shell comprises a sheath made from plastic and arranged to form the first journal.

11. The bearing device according to claim 4 wherein the bearing shell comprises, in the area of the first journal, cutouts penetrated by the sheath.

12. The bearing device according to claim 5, further comprising a toothed wheel supported on the ring section.

13. A bearing device comprising
a housing made of plastic.
a bearing shell with an essentially cylindrical sheath-shaped ring section as a radial section adjoining and held in the housing part,
an inner shaft guided in the bearing shell on a first journal
a second rotatable part surrounding the inner shaft guided on a second journal of the bearing shell wherein
the bearing shell is a metal shell whereby at least the radial section of the bearing shell is injection-moulded into the housing part and the bearing shell on the radial section has a form produced by notches on its edge or holes of the radial section, which changes the length enclosed by the plastic moulding.

14. The bearing device according to claim 13, wherein the ring section comprises a bead arranged to font the first journal.

15. The bearing device according to claim 13,
wherein the bearing shell comprises a sheath made from plastic and arranged to form the first journal.

16. The bearing device according to claim 15, wherein the sheath comprises a one piece housing.

17. The bearing device according to claim 15, wherein the bearing shell comprises, in the area of the first journal, cutouts penetrated by the sheath.

18. The bearing device according to claim 13, further comprising a toothed wheel supported on the ring section.

19. The bearing device according to claim 18, further comprising an axial locking past for the toothed wheel embodied in one piece with the rifle section.

20. The bearing device according to claim 19, wherein the axial locking part is embodied as a bent spring.

21. The bearing device according to claim 14, wherein the bearing shell comprises a sheath made from plastic and arranged to form the first journal.

22. The bearing device according to claim 16 wherein the bearing shell comprises, in the area of the first journal, cutouts penetrated by the sheath.

23. The bearing device according to claim 17, further comprising a toothed wheel supported on the ring section.
